(19) United States
(12) Patent Application Publication
(10) Pub. No.: US 2025/0342651 A1
(43) Pub. Date: Nov. 6, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Chiaki KANEKO, Kanagawa (JP)

(21) Appl. No.: 19/188,431

(22) Filed: Apr. 24, 2025

(30) Foreign Application Priority Data
May 1, 2024 (JP) 2024-074382

(51) Int. Cl. G06T 15/20; G06T 7/557; G06T 7/70; G06T 7/80

(52) U.S. Cl. CPC G06T 15/20; G06T 7/557; G06T 7/70; G06T 7/80; G06T 2207/20081

(57) ABSTRACT

Radiance fields are estimated separately for each object for a scene in which a plurality of objects are present. An information processing apparatus obtains data on a plurality of captured images obtained through image capturing from a plurality of viewpoints, a camera parameter in image capturing of each of the plurality of captured images, and object information indicating a position of each of a plurality of objects included as representations in the captured images, sets a plurality of learning regions based on the object information, associates a three-dimensional space model with each of the plurality of learning regions based on a number of objects included in each of the plurality of learning regions, and performs learning of the three-dimensional space model associated with each of the plurality of learning regions based on the data on the plurality of captured images, the camera parameter, and the object information.

### BACKGROUND

### Field

The present disclosure relates to an information processing technique for modeling a target space.

### Description of the Related Art

There is a technique of estimating radiance fields relating to an object present in a target space based on a plurality of captured images (hereinafter referred to as “multi-viewpoint images”) obtained through image capturing from a plurality of viewpoints. There is also a technique of using the estimated radiance fields to generate an image (hereinafter referred to as “virtual viewpoint image”) corresponding to a view of an object from an arbitrary virtual viewpoint (hereinafter referred to as “virtual viewpoint”). A space targeted for estimation of radiance fields is hereinafter referred to as a “scene.”

“DeRF: Decomposed Radiance Fields” (hereinafter referred to as “Non-patent Literature 1”) discloses a technique of estimating radiance fields by deep learning using multi-viewpoint images as training data. Specifically, the technique (hereinafter referred to as “prior art”) disclosed in Non-patent Literature 1 determines pixel values of a virtual viewpoint image by adding up colors weighted using a volume density along a ray starting from a position of an arbitrary viewpoint based on estimated radiance fields. More specifically, the prior art estimates radiance fields of each of a plurality of convex polyhedron regions obtained by dividing the entire scene so that the regions do not overlap one another, thereby increasing the efficiency of learning of radiance fields and generation of a virtual viewpoint image even in a case where a target space is a huge scene.

### SUMMARY

In the prior art, the regional division is made based on the distribution of volume density roughly estimated based on multi-viewpoint images. In this regional division, however, the positional relationship between objects is not taken into consideration. Further, depending on the shapes, arrangement, or the like of objects, it may be difficult to make a division into a plurality of convex polyhedron regions so that a plurality of objects are not included in the same divided region. Specifically, for example, in a case where the shapes of objects are complicated or objects are close to one another in a target space, a plurality of objects may be included in the same divided region. In the prior art, even in a case where a plurality of objects are included in the same divided region, learning of radiance fields is performed to output one color and one volume density for an arbitrary position and direction. Accordingly, the volume density expressed by radiance fields in the prior art is the combined total of volume densities of a plurality of objects included in the divided region. As stated above, the prior art cannot obtain a volume density of each object.

The present disclosure discloses a technique of enabling estimation of radiance fields for each object even in a case where a plurality of objects are present in a target space.

An information processing apparatus according to the present disclosure comprises: one or more hardware processors; and one or more memories storing one or more programs configured to be executed by the one or more hardware processors, the one or more programs including instructions for: obtaining data on a plurality of captured images obtained through image capturing from a plurality of viewpoints and a camera parameter in image capturing of each of the plurality of captured images; obtaining object information indicating a position of each of a plurality of objects included as representations in the captured images; setting a plurality of learning regions based on the object information; associating a three-dimensional space model with each of the plurality of learning regions based on a number of objects included in each of the plurality of learning regions; and performing learning of the three-dimensional space model associated with each of the plurality of learning regions based on the data on the plurality of captured images, the camera parameter, and the object information.

Further features of the present disclosure will become apparent from the following description of exemplary embodiments with reference to the attached drawings.

### BRIEF DESCRIPTION OF THE DRAWINGS

FIG. 1 is a block diagram showing an example of a hardware configuration of an information processing apparatus according to a first embodiment;

FIG. 2 is a block diagram showing an example of a logical configuration of the information processing apparatus according to the first embodiment;

FIG. 3 is a diagram showing an example of an arrangement of objects and image capturing apparatuses according to the first embodiment;

FIGS. 4A to 4C are diagrams showing an example of multi-viewpoint images according to the first embodiment;

FIG. 5 is a flowchart showing an example of a processing flow of the information processing apparatus according to the first embodiment;

FIGS. 6A and 6B are diagrams showing an example of GUIs according to the first embodiment;

FIG. 7 is a diagram showing an example of bounding boxes according to the first embodiment;

FIGS. 8A to 8I are diagrams showing an example of silhouette images according to the first embodiment;

FIGS. 9A to 9D are diagrams for illustrating an example of learning regions according to the first embodiment;

FIG. 10 is a diagram showing an example of a ray according to the first embodiment; and

FIG. 11 is a diagram showing an example of a virtual viewpoint image according to the first embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

The present embodiment describes an aspect of setting a plurality of regions as regions (hereinafter referred to as “learning region”) for which learning is performed based on a position of each of a plurality of objects. For example, the present embodiment describes an aspect in which radiance fields in each learning region are expressed by a three-dimensional space model (hereinafter simply referred to as “model”) which outputs a color and a volume density of each object included in the region.

### <Hardware Configuration of Information Processing Apparatus>

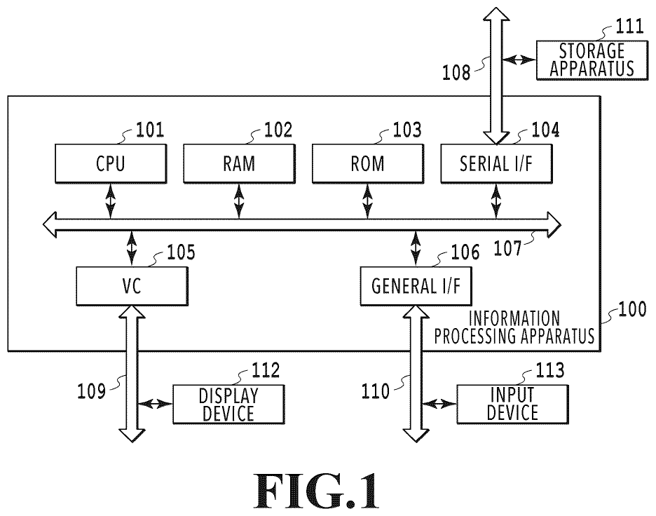

FIG. 1 is a block diagram showing an example of a hardware configuration of an information processing apparatus 100 according to the first embodiment. As hardware elements, the information processing apparatus 100 comprises a CPU 101, a RAM 102, a ROM 103, a serial interface (I/F) 104, a video card (VC) 105, and a general I/F 106. The units comprised as hardware elements in the information processing apparatus 100 are connected so as to communicate with one another via a system bus 107. The CPU 101 uses the RAM 102 as work memory and executes an operating system (OS) and various programs stored in the ROM 103, a storage apparatus 111, or the like. The CPU 101 controls the entire information processing apparatus 100 via the system bus 107 by executing various programs. Incidentally, processing in each step shown in the flowchart described later is implemented by a program code stored in the ROM 103, the storage apparatus 111, or the like being loaded into the RAM 102 and executed by the CPU 101.

The serial I/F 104 is an interface formed by a serial ATA or the like. The information processing apparatus 100 and the storage apparatus 111 are connected via a serial bus 108. The storage apparatus 111 is a bulk storage device such as a hard disk drive (HDD) or a solid-state drive (SSD). Although it is assumed in the present embodiment that the storage apparatus 111 is an apparatus external to the information processing apparatus 100, the information processing apparatus 100 may include the storage apparatus 111 therein. The VC 105 receives a control signal from the CPU 101 and outputs a signal relating to a display image to a display device 112 via a serial bus 109. The display device 112 is formed by a liquid crystal display or the like and displays a display image based on a signal relating to the display image output from the information processing apparatus 100. The general I/F 106 is connected to an input device 113 such as a mouse or keyboard via a serial bus 110 and receives an input signal from the input device 113.

The CPU 101 displays a graphical user interface (GUI) provided by a program on the display device 112 via the VC 105 and receives an input signal indicating a user instruction obtained via the input device 113. The information processing apparatus 100 is implemented by, for example, a desktop personal computer (PC). The information processing apparatus 100 may be implemented by a laptop PC, a tablet PC, or the like integrated with the display device 112. Further, the storage apparatus 111 may be implemented by a medium (portable storage medium) and a drive such as a disk drive or a reader such as a memory card reader to access the medium. The medium may be a flexible disk (FD), CD-ROM, DVD, USB memory, MO, or flash memory.

### <Logical Configuration of Information Processing Apparatus>

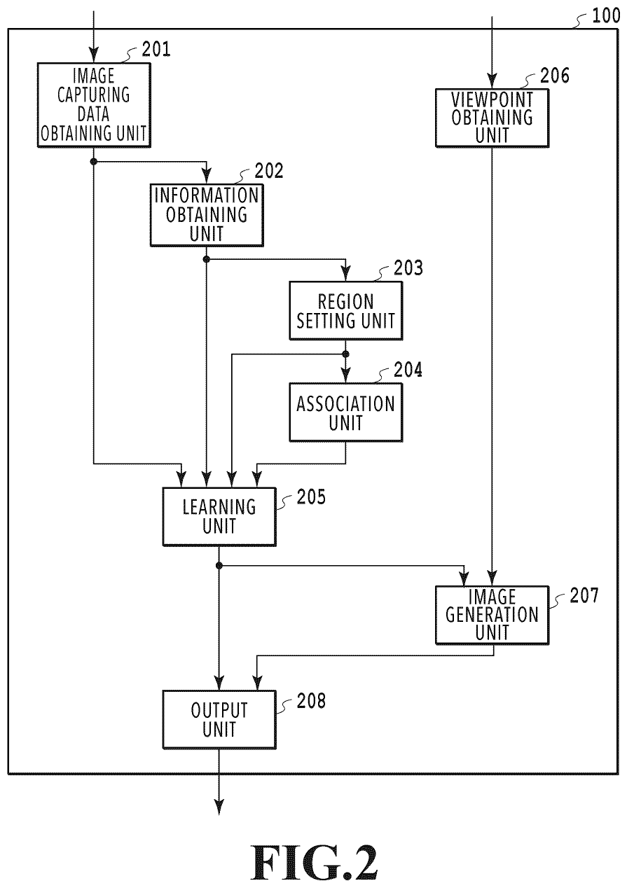

FIG. 2 is a block diagram showing an example of a logical configuration of the information processing apparatus 100 according to the first embodiment. As logical elements, the information processing apparatus 100 comprises an image capturing data obtaining unit 201, an information obtaining unit 202, a region setting unit 203, an association unit 204, a learning unit 205, a viewpoint obtaining unit 206, an image generation unit 207, and an output unit 208. The units comprised as logical elements in the information processing apparatus 100 are implemented by the CPU 101 executing a program stored in the ROM 103 or the like using the RAM 102 as work memory. It should be noted that not all of the following processes necessarily have to be implemented by execution of a program by the CPU 101 and the information processing apparatus 100 may be configured so that one or more processing circuits other than the CPU 101 execute part or all of the processes.

The image capturing data obtaining unit 201 obtains a plurality of pieces of captured image (multi-viewpoint image) data obtained by capturing images of objects present in a predetermined scene from various viewpoints under a user instruction input via the input device 113. For example, it is assumed below that the captured image data obtained by the image capturing data obtaining unit 201 is image data in an RGB image format. The image capturing data obtaining unit 201 may obtain the captured image data output from the image capturing apparatus directly from the image capturing apparatus or may obtain the captured image data by reading the captured image data from the storage apparatus 111 or the like which stores the captured image data in advance. The obtained multi-viewpoint image data is transmitted to the information obtaining unit 202 and the learning unit 205.

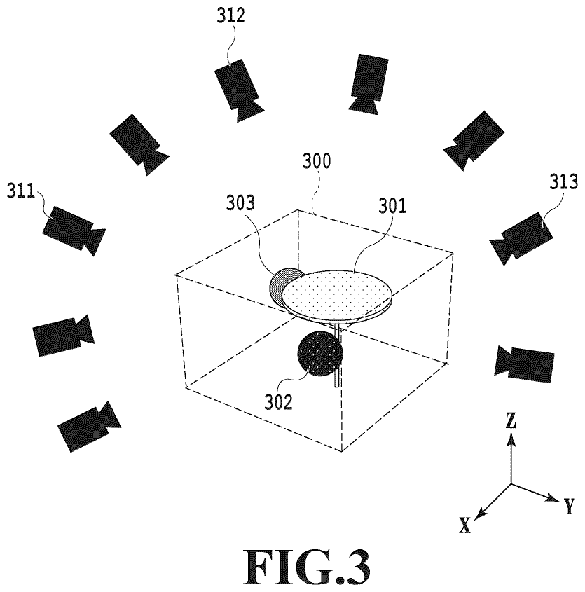

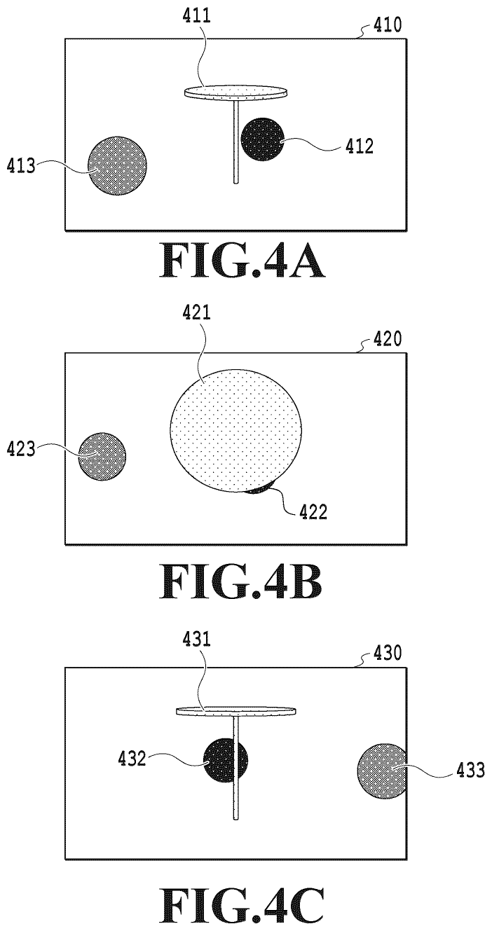

FIG. 3 is a diagram showing an example of an arrangement of objects 301 to 303 present in a scene 300 and a plurality of image capturing apparatuses including image capturing apparatuses 311 to 313 capturing images of the objects 301 to 303 according to the first embodiment. FIGS. 4A to 4C are diagrams showing an example of multi-viewpoint images obtained by the image capturing data obtaining unit 201 according to the first embodiment. Specifically, FIGS. 4A to 4C show an example of captured images 410, 420, and 430 obtained through image capturing by the respective image capturing apparatuses 311 to 313. More specifically, FIG. 4A shows an example of the captured image 410 obtained through image capturing by the image capturing apparatus 311. FIG. 4B shows an example of the captured image 420 obtained through image capturing by the image capturing apparatus 312. FIG. 4C shows an example of the captured image 430 obtained through image capturing by the image capturing apparatus 313. The captured images 410, 420, and 430 include representations 411, 421, and 431 of the object 301, representations 412, 422, and 432 of the object 302, and representations 413, 423, and 433 of the object 303.

The image capturing data obtaining unit 201 also obtains camera parameters of each of the image capturing apparatuses including the image capturing apparatuses 311 to 313 which have captured the respective captured images constituting the multi-viewpoint images. It is assumed below that the camera parameters obtained by the image capturing data obtaining unit 201 include intrinsic parameters, extrinsic parameters, and a distortion parameter of the image capturing apparatus. The intrinsic parameters are parameters indicating a position of a principal point of the image capturing apparatus and a focal length of a lens of the image capturing apparatus. The extrinsic parameters are parameters indicating a position of the image capturing apparatus and a direction of an optical axis of the image capturing apparatus, that is, an orientation of the image capturing apparatus. The distortion parameter is a parameter indicating a distortion of the lens of the image capturing apparatus.

Although it is assumed below that the image capturing data obtaining unit 201 obtains the camera parameters of the image capturing apparatuses by requesting them from each image capturing apparatus, the source from which the camera parameters are obtained is not limited to the image capturing apparatus. For example, the image capturing data obtaining unit 201 may obtain the camera parameters by reading the camera parameters from the storage apparatus 111 or the like which stores the camera parameters in advance. The obtained camera parameters of each image capturing apparatus are transmitted to the information obtaining unit 202 and the learning unit 205.

The information obtaining unit 202 obtains three-dimensional shape data on each of the objects 301 to 303 by estimating an approximate shape of each of the objects 301 to 303 based on the multi-viewpoint image data and camera parameters obtained by the image capturing data obtaining unit 201. Further, based on the estimated approximate shapes, the information obtaining unit 202 obtains bounding box data including an identification number and information indicating a position and size of a bounding box surrounding the approximate shape of each of the objects 301 to 303. The estimation processing of the approximate shape and the obtaining processing of the bounding box data by the information obtaining unit 202 will be described later in detail. The obtained bounding box data is transmitted to the region setting unit 203. The information obtaining unit 202 also obtains silhouette image data indicating a silhouette of each of the objects 301 to 303 corresponding to each of the captured images constituting the multi-viewpoint images. The obtaining processing of the silhouette image data by the information obtaining unit 202 will be described later in detail. The obtained silhouette image data is transmitted to the learning unit 205.

Although it is assumed in the present embodiment that the information obtaining unit 202 obtains the three-dimensional shape data on each of the objects 301 to 303 by estimating the approximate shape of each of the objects 301 to 303, the method for obtaining the three-dimensional shape data is not limited to this. For example, the information obtaining unit 202 may obtain three-dimensional shape data by receiving, from an external apparatus, the three-dimensional shape data obtained by the external apparatus estimating the approximate shape of each the objects 301 to 303 based on the multi-viewpoint image data and camera parameters. Further, although it is assumed in the present embodiment that the information obtaining unit 202 obtains the bounding box data by generating the bounding box data based on the approximate shapes, the method for obtaining the bounding box data is not limited to this. For example, the information obtaining unit 202 may obtain bounding box data by receiving, from an external apparatus, the bounding box data generated by the external apparatus based on the approximate shapes.

The region setting unit 203 sets learning regions in the scene based on the bounding box data obtained by the information obtaining unit 202. The setting processing of the learning regions by the region setting unit 203 will be described later in detail. Information indicating the set learning regions (hereinafter referred to as “learning region information”) is transmitted to the association unit 204 and the learning unit 205. The association unit 204 associates, with each of the learning regions set by the region setting unit 203, one model including at least a number of volume densities corresponding to the number of objects in the learning region as output parameters. The processing by the association unit 204 will be described later in detail. The information on the associated models is transmitted to the learning unit 205.

The learning unit 205 estimates radiance fields based on the multi-viewpoint image data and camera parameters obtained by the image capturing data obtaining unit 201 and the silhouette image data obtained by the information obtaining unit 202. Specifically, the learning unit 205 estimates radiance fields relating to each learning region set by the region setting unit 203. For example, in the present embodiment, it is assumed that the learning unit 205 estimates radiance fields which relate to each learning region and are expressed by a model associated by the association unit 204. The estimating processing of the radiance fields by the learning unit 205 will be described later in detail. Information on the model indicating the radiance fields estimated by the learning unit 205 is transmitted to the generation unit 207 and the output unit 208.

The viewpoint obtaining unit 206 obtains information about a virtual viewpoint (hereinafter referred to as “virtual viewpoint information”). The virtual viewpoint information includes at least camera parameters relating to the virtual viewpoint (hereinafter referred to as “virtual camera parameters”) and the virtual camera parameters include information indicating a position of the virtual viewpoint and information indicating a viewing direction at the virtual viewpoint. In order to distinguish the camera parameters of the image capturing apparatuses from the virtual camera parameters, the camera parameters of the image capturing apparatuses are hereinafter simply referred to as “camera parameters.” In addition to the virtual camera parameters, the virtual viewpoint information may include pixel number information indicating the number of pixels of a virtual viewpoint image generated by the image generation unit 207 and object information such as an identification number capable of uniquely specifying an object included as a representation in the virtual viewpoint image. The virtual viewpoint information may also include information indicating a viewing angle from the virtual viewpoint or the like. The virtual viewpoint information is obtained, for example, under a user instruction input via the input device 113. The virtual viewpoint information obtained by the viewpoint obtaining unit 206 is transmitted to the image generation unit 207.

The image generation unit 207 generates a virtual viewpoint image using the virtual viewpoint information obtained by the viewpoint obtaining unit 206 and the radiance fields estimated by the learning unit 205. The generation processing of the virtual viewpoint image by the image generation unit 207 will be described later in detail. Data on the virtual viewpoint image generated by the image generation unit 207 is transmitted to the output unit 208. The output unit 208 outputs the virtual viewpoint image generated by the image generation unit 207. Specifically, for example, the output unit 208 generates a display image including the virtual viewpoint image, outputs a signal relating to the display image to the display device 112, and causes the display device 112 to display the display image. The destination to which the virtual viewpoint image is output is not limited to the display device 112. For example, the output unit 208 may output the data on the virtual viewpoint image to the storage apparatus 111 and cause the storage apparatus 111 to store the data, or may output the data to another external apparatus different from the information processing apparatus 100. The output unit 208 also outputs information on the model indicating the radiance fields estimated by the learning unit 205. Specifically, the output unit 208 may output the information on the model indicating the radiance fields to the storage apparatus 111 and causes the storage apparatus 111 to store the information or may output the information to another external apparatus different from the information processing apparatus 100.

### <Operation of Information Processing Apparatus>

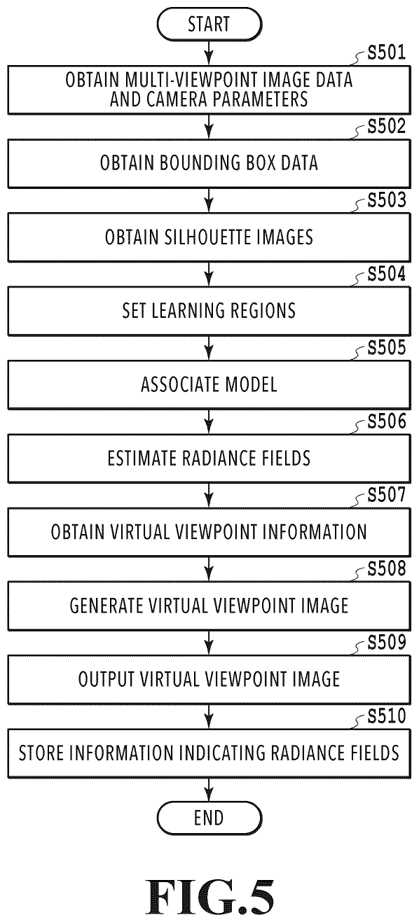

FIG. 5 is a flowchart showing an example of a processing flow in the information processing apparatus 100 according to the first embodiment. Incidentally, “S” at the head of each reference numeral means a step. First, in S501, the image capturing data obtaining unit 201 obtains the multi-viewpoint image data and the camera parameters corresponding to each of the captured images constituting the multi-viewpoint images under a user instruction.

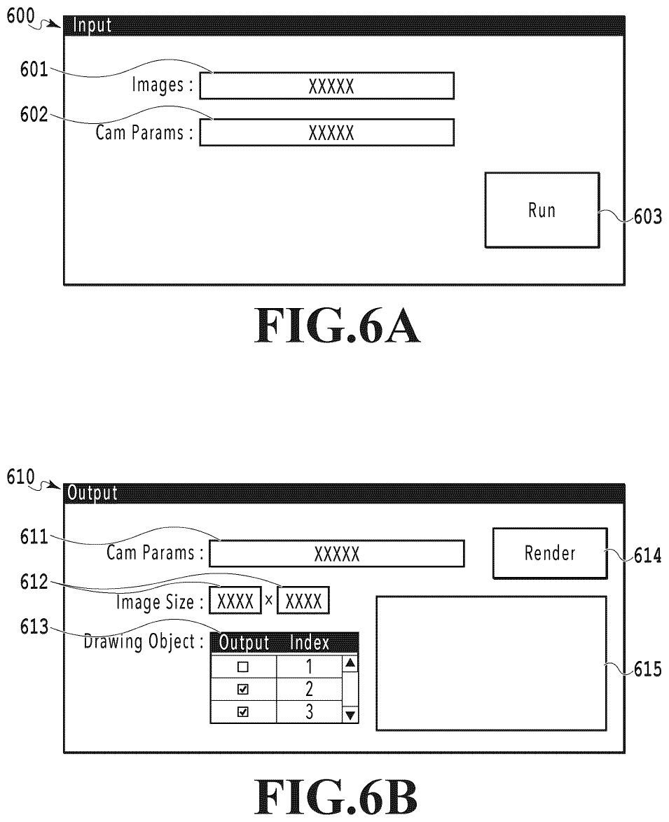

FIGS. 6A and 6B are diagrams showing an example of GUIs 600 and 610 displayed on the display device 112 according to the first embodiment. The user instruction in S501 is accepted via the GUI 600 illustrated in FIG. 6A. In FIG. 6A, data path setting fields 601 and 602 are fields to accept input of data paths indicating the locations of files including the multi-viewpoint image data and the camera parameter data as data, respectively. A button 603 is a button pressed to issue an instruction to execute processing described later. In a case where the button 603 is pressed by a user, the information processing apparatus 100 executes the processing of S502 after the execution of the processing of S501. FIG. 6B will be described later.

After S501, in S502, the information obtaining unit 202 obtains bounding box data corresponding to each object present in the scene based on the multi-viewpoint image data and camera parameters obtained in S501. Specifically, the information obtaining unit 202 first generates and obtains a difference image indicating a difference between an image showing no object (hereinafter referred to as “background image”) and each of the captured images constituting the multi-viewpoint images. Data on the background image is prepared by, for example, capturing in advance an image of the scene in which no object is present. Although it is assumed in the present embodiment that the information obtaining unit 202 generates the difference images, the information obtaining unit 202 may obtain the difference images by receiving data on the difference images generated by an external apparatus.

Next, the information obtaining unit 202 estimates a three-dimensional shape of each object present in the scene based on the difference image and camera parameters corresponding to each captured image. A well-known three-dimensional shape estimation technique such as a visual hull or stereo matching method may be used for the estimation of the three-dimensional shape. In the present embodiment, it is assumed that the visual hull method is used and three-dimensional shape data represented by a set of voxels is obtained as data indicating an approximate shape of an object. The approximate shape obtained by the information obtaining unit 202 only has to show a position and rough shape of each object in the target space and does not need to show small asperities relating to each object or a color of the object.

Next, the information obtaining unit 202 regards a set of spatially continuous voxels forming the obtained approximate shape as one object and thereby associates each set of voxels with an identification number corresponding to one object. Next, the information obtaining unit 202 calculates a position and size of a rectangular cuboid (bounding box) circumscribing each set of voxels associated with the identification number. Through the above processing, the information obtaining unit 202 obtains bounding box data about each object, namely information indicating the position and size of the bounding box surrounding each object provided with the identification number.

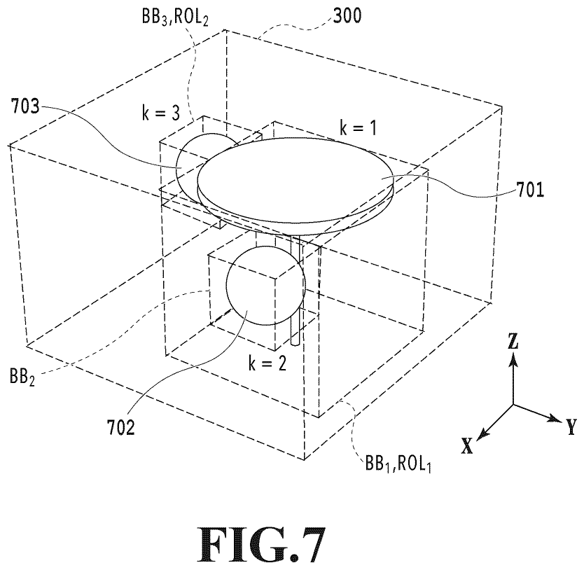

FIG. 7 is a diagram showing an example of bounding boxes obtained by the information obtaining unit 202 according to the first embodiment. Specifically, FIG. 7 shows an example of approximate shapes 701 to 703 of the objects 301 to 303 obtained in relation to the scene 300 shown in FIG. 3 and bounding boxes corresponding to the approximate shapes 701 to 703. In FIG. 7, the approximate shapes 701, 702, and 703 each associated with an identification number k (1, 2, or 3) show approximate shapes corresponding to the objects 301, 302, and 303 shown in FIG. 3, respectively. Bounding boxes BB₁, BB₂, and BB₃ are rectangular cuboids circumscribing the approximate shapes 701, 702, and 703, respectively, and having each side parallel to any of three-dimensional coordinate axes indicating a position in the target space. In the following description, an object corresponding to an approximate shape with an identification number k is denoted by OBJₖ, the total number of objects present in the scene is denoted by K, and a bounding box corresponding to the object OBJₖ is denoted by BBₖ.

Incidentally, although it is assumed in the present embodiment that the information obtaining unit 202 obtains an approximate shape by estimating a three-dimensional shape of an object based on multi-viewpoint images, the method of obtaining an approximate shape of an object is not limited to this. For example, the information obtaining unit 202 may obtain an approximate shape of an object by reading, from the storage apparatus 111 or the like, data on the approximate shape of the object separately prepared or estimated in advance by another external apparatus or the like under a user instruction.

Further, although it is assumed in the present embodiment that the information obtaining unit 202 obtains an approximate shape represented by voxels, the information obtaining unit 202 may obtain an approximate shape represented by constituent elements other than voxels. For example, the approximate shape may be represented by a surface shape formed of a polygon mesh having a plurality of polygons. In this case, it is only necessary to regard a polygon mesh having consecutive polygons connected by their sides as an approximate shape of one object.

Further, although it is assumed in the present embodiment that the information obtaining unit 202 calculates a position and size of a bounding box which is a rectangular cuboid circumscribing an approximate shape, the shape of a bounding box is not limited to a rectangular cuboid. For example, the shape of a bounding box may be any three-dimensional shape other than the rectangular cuboid, such as a convex polyhedron or a sphere, as long as it is convex and includes therein an approximate shape of each object.

After S502, in S503, the information obtaining unit 202 obtains silhouette image data indicating a silhouette of each object corresponding to each of the captured images constituting the multi-viewpoint images based on the multi-viewpoint image data and camera parameters obtained in S501. Specifically, the information obtaining unit 202 obtains silhouette image data indicating the visibility of each object by projecting the approximate shape of the object estimated in S502 on each captured image plane based on the camera parameters.

More specifically, the information obtaining unit 202 first prepares a silhouette image with all pixel values initialized to 0 corresponding to each of the captured images constituting the multi-viewpoint images for each of the identification numbers of the objects. Next, the information obtaining unit 202 projects the approximate shape of each object individually on the image plane using the camera parameters and thereby generates depth images corresponding to all the captured images constituting the multi-viewpoint images for each identification number. A well-known computer graphics technique may be used for the generation of the depth images. Next, for each pixel of the generated depth images, the information obtaining unit 202 specifies such an identification number k_{dmin} that a pixel value, namely a depth value, is less than a threshold dₘₐₓ and is minimum, and sets a pixel value of the silhouette image corresponding to the specified identification number k_{dmin} at 1. It is assumed here that the threshold dₘₐₓ is a maximum value of depth in the scene and is set in advance based on the relative positional relationship between the scene and the position of the image capturing apparatus indicated by the camera parameters.

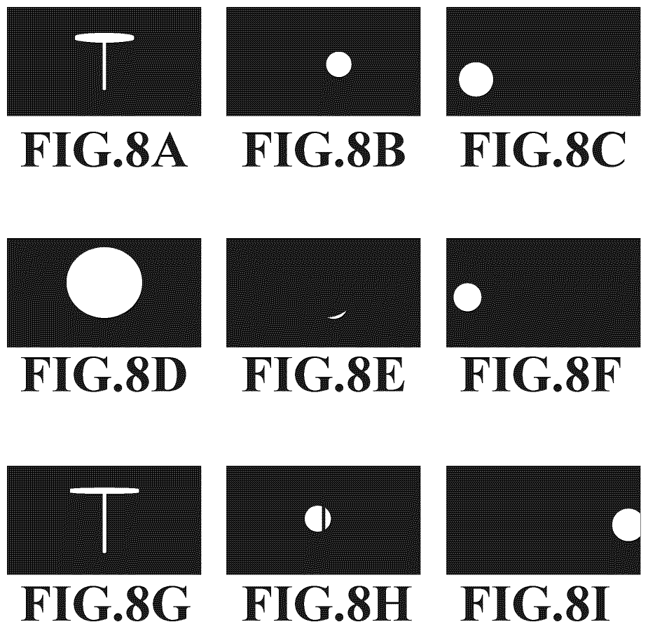

FIGS. 8A to 8I are diagrams showing an example of the silhouette images obtained by the information obtaining unit 202 according to the first embodiment. In the silhouette images illustrated in FIGS. 8A to 8I, pixels of regions corresponding to silhouettes of the objects are shown in white whose pixel value is 1 and the other regions are shown in black whose pixel value is 0. Specifically, FIGS. 8A, 8B, and 8C are silhouette images of the objects associated with the identification numbers k=1, 2, and 3, respectively, corresponding to the captured image 410. FIGS. 8D, 8E, and 8F are silhouette images of the objects associated with the identification numbers k=1, 2, and 3, respectively, corresponding to the captured image 420. FIGS. 8G, 8H, and 8I are silhouette images of the objects associated with the identification numbers k=1, 2, and 3, respectively, corresponding to the captured image 430. Each of the silhouette images shown in FIGS. 8A to 8I indicates a pixel region including a representation of an object associated with the corresponding identification number in the corresponding captured image.

After S503, in S504, the region setting unit 203 sets learning regions based on the bounding box data obtained in S502. Specifically, in a case where a bounding box BBₖ does not have a region overlapping with any other bounding box in the target space, the region setting unit 203 sets the bounding box BBₖ as one of the learning regions. Otherwise, the region setting unit 203 sets, as one of the learning regions, a three-dimensional convex region which includes the whole of the bounding box BB and one or more bounding boxes having an overlapping region and does not overlap with any other learning region.

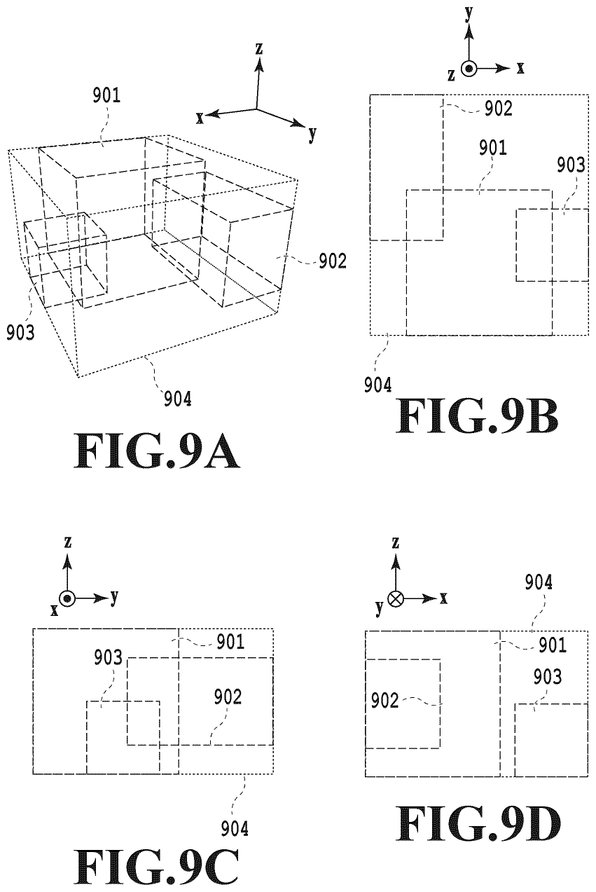

FIGS. 9A to 9D are diagrams for illustrating an example of the learning regions set by the region setting unit 203 according to the first embodiment. For three bounding boxes 901 to 903 having overlapping regions illustrated in FIGS. 9A to 9D, the region setting unit 203 sets a minimum rectangular cuboid 904 including these three bounding boxes 901 to 903 as one of the learning regions.

Further, the region setting unit 203 outputs the number of objects corresponding to the respective bounding boxes included in each of the set learning regions and the identification numbers of the respective objects in association with information indicating that learning region. In the example shown in FIG. 7, the bounding box BB₁ including the bounding box BB₂ therein is set as a learning region ROL₁ including the bounding boxes corresponding to the two objects with the identification numbers k=1 and 2. Further, the bounding box BB₃ not having a region overlapping with any other bounding box is set as a learning region ROL₂ including the bounding box corresponding to the single object with the identification number k=3. Through the above processing, the two learning regions ROL₁ and ROL₂ are set for the scene 300.

After S504, in S505, the association unit 204 associates, with each learning region set in S504, one model including at least a number of volume densities corresponding to the number of objects in the learning region as output parameters. Specifically, for example, the association unit 204 associates the model expressed by the following equation (1) with a learning region in which the number of objects in the learning region is K′:

$${F}_{Θ} : ( x , y , z , θ , φ ) \to ( R , G , B , {σ}_{id 1} , … , {σ}_{{idK}^{′}} ) \qquad equation ( 1 )$$

Here, (x, y, z) represent three-dimensional coordinates indicating a position in the target space, (θ, q) represent a direction in the target space, and (R, G, B) represent a color determined by the position and direction in the target space. (σ_{id1}, . . . , σ_{idK′}) represent a volume density determined by the position of each of the K′ objects with the identification numbers id1, . . . , idK′. The function F_{Θ} formulated by the equation (1) is a model which outputs a color and a volume density of each object for a three-dimensional position and direction as output parameters. For example, the learning region ROL₁ including the two objects with the identification numbers k=1 and 2 is associated with a model which outputs two volume densities σ₁ and σ₂ corresponding to the respective objects. Further, the learning region ROL₂ including the single object with the identification number k=3 is associated with a model which outputs a single volume density σ₃.

After S505, in S506, the learning unit 205 estimates radiance fields expressed by the model associated in S505 with each learning region set in S504. Specifically, the learning unit 205 estimates radiance fields expressed by the model associated with each learning region based on the multi-viewpoint image data and camera parameters obtained in S501 and the silhouette image data obtained in S503. In the present embodiment, it is assumed that radiance fields are estimated by performing learning by deep learning for a model in which the function F_{Θ} illustrated by the equation (1) is implemented by a multilayer perceptron (MLP). It is also assumed that radiance fields are expressed as MLP parameters, that is, weight parameters concerning nodes forming the MLP, and the weight parameters are stored in a memory region secured in the RAM 102 for each learning region.

Further, it is assumed in the present embodiment that the learning unit 205 performs MLP learning as follows. First, based on the outputs from the model, the learning unit 205 generates a virtual viewpoint image corresponding to each of the captured images constituting the multi-viewpoint images obtained in S501 and generates a silhouette image of each objet based on the virtual viewpoint image (hereinafter referred to as “virtual silhouette image”). Next, the learning unit 205 optimizes the weight parameters of the MLP so that the pixel values of these images are close to the pixel values of the captured images constituting the multi-viewpoint images obtained in S501 and the silhouette images obtained in S503, respectively. Specifically, for example, first, for a ray r corresponding to each pixel of the captured image, the learning unit 205 calculates a training signal C_{GT}(r) expressed by the following equation (2) and a prediction signal C_{pred}(r) expressed by the following equation (3) based on the output values from the model associated with each learning region. The learning unit 205 then calculates a squared Euclidean distance between the training signal C_{GT}(r) and the prediction signal C_{pred}(r) and uses it as a loss to perform MLP learning by backpropagation.

$${C}_{GT} ( r ) = ( \begin{matrix}{I}_{R} ( r ) \\ {I}_{G} ( r ) \\ {I}_{B} ( r ) \\ {I}_{{S}_{1}} ( r ) \\ {I}_{{S}_{2}} ( r ) \\ ⋮ \\ {I}_{{S}_{K}} ( r )\end{matrix} ) \qquad equation ( 2 )$$

$${C}_{pred} ( r ) = ( \begin{matrix}R ( r ) \\ G ( r ) \\ B ( r ) \\ {S}_{1} ( r ) \\ {S}_{2} ( r ) \\ ⋮ \\ {S}_{K} ( r )\end{matrix} ) \qquad equation ( 3 )$$

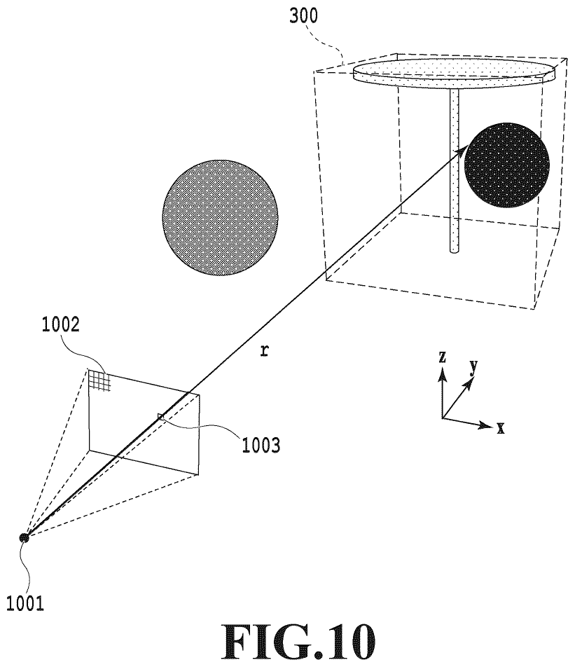

In the equation (2), r is a ray determined based on the position of a pixel in the captured image and the camera parameters. I_{R}(r), I_{G}(r), and I_{B}(r) are pixel values of the captured image corresponding to the ray r and I_{Sk}(r) is a pixel value of the silhouette image of the object OBJₖ corresponding to the ray r. FIG. 10 is a diagram showing an example of the positional relationship among the ray r set by the learning unit 205, the scene 300, a position 1001 of the image capturing apparatus, an image plane 1002, and a pixel 1003 corresponding to the ray r according to the first embodiment. In the equation (3), R(r), G(r), and B(r) are pixel values of the virtual viewpoint image corresponding to the ray r and are calculated, for example, using the following equation (4). Sₖ(r) is a pixel value of the virtual silhouette image of the object OBJₖ corresponding to the ray r corresponding to the virtual viewpoint image and is calculated, for example, using the following equation (5).

$$( \begin{matrix}R ( r ) \\ G ( r ) \\ B ( r )\end{matrix} ) = {\sum }_{i = 1}^{N} T ( i ) α ( i ) ( \begin{matrix}R ( i ) \\ G ( i ) \\ B ( i )\end{matrix} ) \qquad equation ( 4 )$$

$${S}_{k} ( r ) = \{ \begin{matrix}1 & if {\sum }_{i = 1}^{N} T ( i ) {α}_{k} ( i ) > 0 , \\ 0 & otherwize .\end{matrix} \qquad equation ( 5 )$$

Here, the equation (4) is equivalent to well-known volume rendering of an RGB image. In the equation (4), i is an index of a sampling point of the ray r and N is the number of sampling points. R(i), G(i), and B(i) are RGB values corresponding to the sampling point and are output from a model associated with a learning region including the sampling point. T(i) is the cumulative transmittance from the position of the image capturing apparatus to the sampling point and is calculated, for example, using the following equation (6). α(i) is the opacity of sampling points combined for all the objects and is calculated, for example, using the following equation (7). In the equation (5), αₖ(i) is the opacity of sampling points concerning the object OBJₖ and is calculated, for example, using the following equation (8).

$$T ( i ) = exp ( - {\sum }_{j = 1}^{i - 1} {\sum }_{k = 1}^{K} {σ}_{k} ( j ) {δ}_{j} ) \qquad equation ( 6 )$$

$$α ( i ) = {\sum }_{k = 1}^{K} {α}_{k} ( i ) \qquad equation ( 7 )$$

$${α}_{k} ( i ) = 1 - exp ( - {σ}_{k} ( i ) {δ}_{i} ) \qquad equation ( 8 )$$

In the equation (6), j is an index of a sampling point in front of the ith sampling point of the ray r, and σₖ(j) is a volume densify of the object OBJₖ for the sampling point and is a value output from a model associated with the learning region including the sampling point. However, in a case where the output parameters of the model do not include the volume densify of the object OBJₖ, the value of σₖ(j) is treated as 0 for the sake of calculation. δⱼ is a distance between the jth sampling point and the j+1th sampling point.

As described above, the learning unit 205 performs learning of the model so that a difference becomes small not only between the captured image and the RGB image of the virtual viewpoint image but also between the silhouette image and the virtual silhouette image for each object. According to the model obtained through the above learning, a volume density may be estimated for each object. Incidentally, since the learning region according to the present embodiment is a convex polyhedron not overlapping with any other learning region, the information processing apparatus 100 according to the present embodiment may generate a virtual viewpoint image using the “Painter's Algorithm” as disclosed in Non-patent Literature 1. Further, although it is assumed in the present embodiment that the function F_{Θ} is implemented by the MLP, the function F_{Θ} may be implemented by means other than the MLP. For example, the function F_{Θ} may be implemented by using a sparse voxel grid storing a volume density and a coefficient of spherical harmonics indicating a color.

After S506, in S507, the viewpoint obtaining unit 206 obtains the virtual viewpoint information under a user instruction. Next, in S508, the image generation unit 207 generates a virtual viewpoint image using the virtual viewpoint information obtained in S507 and the radiance fields estimated in S506. The user instruction in S507 is accepted via the GUI 610 displayed on the display device 112 illustrated in FIG. 6B.

In FIG. 6B, a virtual camera parameter setting field 611 is a field to accept input of a data path indicating the location of virtual camera parameter data used to generate a virtual viewpoint image. An image size setting field 612 is a field to accept input of the number of pixels in each of the lateral and longitudinal directions of a virtual viewpoint image to be generated. An object setting field 613 is a field to accept input of an identification number or the like corresponding to an object to be included as a representation in a virtual viewpoint image. A button 614 is a button pressed to issue an instruction to execute the processing of S508. A display region 615 is a region to display a generated virtual viewpoint image. In a case where the button 614 is pressed by a user, the image generation unit 207 generates a virtual viewpoint image based on the values input to the virtual camera parameter setting field 611, the image size setting field 612, and the object setting field 613.

The image generation unit 207 generates a virtual viewpoint image by, for example, calculating a pixel value C(r) of the virtual viewpoint image using the following equations (9) to (11).

$$C ( r ) = {\sum }_{i = 1}^{N} {T}^{′} ( i ) {α}^{′} ( i ) ( \begin{matrix}R ( i ) \\ G ( i ) \\ B ( i )\end{matrix} ) \qquad equation ( 9 )$$

$${T}^{′} ( i ) = exp ( - {\sum }_{j = 1}^{i - 1} {\sum }_{k ∈ {K}_{draw}} {σ}_{k} ( j ) {δ}_{j} ) \qquad equation ( 10 )$$

$${α}^{′} ( i ) = {\sum }_{k ∈ {K}_{draw}} {α}_{k} ( i ) \qquad equation ( 11 )$$

In the equations (10) and (11), K_{draw} is a set of identification numbers of objects to be included as representations in the virtual viewpoint image. In the present embodiment, in the equation (9), color weighting is performed using a volume density σₖ(i) corresponding to an object to be included as a representation in the virtual viewpoint image. In this manner, a virtual viewpoint image is generated such that objects other than the objects to be included as representations in the virtual viewpoint image are transparent, that is, a virtual viewpoint image including only representations of desired objects is obtained.

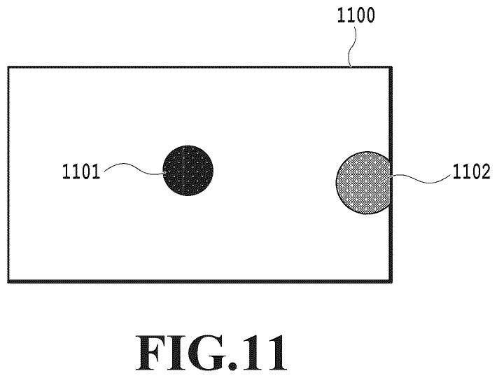

FIG. 11 is a diagram showing an example of a virtual viewpoint image 1100 generated by the image generation unit 207 according to the first embodiment. Specifically, the virtual viewpoint image 1100 is based on the multi-viewpoint images shown in FIGS. 4A to 4C. More specifically, the virtual viewpoint image 1100 is generated in a case where the virtual camera parameters are identical to the camera parameters of the image capturing apparatus 313 of FIG. 3 and the settings are made such that the virtual viewpoint image includes representations of the objects corresponding to the approximate shapes 702 and 703 with the identification numbers k=2 and 3 in FIG. 7. The virtual viewpoint image 1100 does not include a representation of the object corresponding to the approximate shape 701 with the identification number k=1 shown in FIG. 7. The virtual viewpoint image 1100 includes only a representation 1101 of the object corresponding to the approximate shape 702 with the identification number k=2 and a representation 1102 of the object corresponding to the approximate shape 703 with the identification number k=3 shown in FIG. 7.

After S508, in S509, the output unit 208 outputs the virtual viewpoint image generated in S508. For example, the output unit 208 outputs the virtual viewpoint image generated in S508 so that the virtual viewpoint image is displayed in the display region 615 of the GUI 610. Next, in S510, the output unit 208 outputs information indicating the radiance fields estimated in S506, that is, information on the model indicating the radiance fields to a storage apparatus such as the storage apparatus 111 and causes the storage apparatus to store the information. At this time, it is preferable that the output unit 208 cause the storage apparatus to store the information on the model including the identification numbers of the objects corresponding to the volume densities included in the model. In this case, the stored information on the model is used to execute the processing of S507 to S509, whereby a virtual viewpoint image including only representations of desired objects may be obtained without the need to execute the processing of S501 to S506 again. After S510, the information processing apparatus 100 finishes the processing of the flowchart shown in FIG. 5.

According to the information processing apparatus 100 configured as stated above, in a case where a plurality of objects are included in a single learning region, radiance fields may be estimated separately for each object such that an arbitrary object may be identified. Further, according to the information processing apparatus 100, an image (virtual viewpoint image) including only one or more arbitrary objects of a plurality of objects as representations may be generated using the estimated radiance fields.

Incidentally, although it is assumed in the present embodiment that captured images are RGB images for example, captured images may be images represented in any other format such as grayscale images, XYZ images, or YUV images. Further, although it is assumed in the present embodiment that a color of an object is determined by a position and direction for example, a color of an object may be determined only by a position irrespective of a direction.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, radiance fields may be estimated separately for each object for a scene in which a plurality of objects are present.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-074382, filed on May 1, 2024, which is hereby incorporated by reference wherein in its entirety.

What is claimed is:

1. An information processing apparatus comprising:
one or more hardware processors; and
one or more memories storing one or more programs configured to be executed by the one or more hardware processors, the one or more programs including instructions for:
obtaining data on a plurality of captured images obtained through image capturing from a plurality of viewpoints and a camera parameter in image capturing of each of the plurality of captured images;
obtaining object information indicating a position of each of a plurality of objects included as representations in the captured images;
setting a plurality of learning regions based on the object information;
associating a three-dimensional space model with each of the plurality of learning regions based on a number of objects included in each of the plurality of learning regions; and
performing learning of the three-dimensional space model associated with each of the plurality of learning regions based on the data on the plurality of captured images, the camera parameter, and the object information.

2. The information processing apparatus according to claim 1, wherein the one or more programs further include instructions for:
obtaining, as the object information, data on a bounding box including each of the plurality of objects; and
setting each of one or more of the plurality of obtained bounding boxes not having a region overlapping with any other of the bounding boxes as a part of the plurality of learning regions and setting a region including two or more of the plurality of bounding boxes whose regions overlap at least partially with one another as a part of the plurality of learning regions.

3. The information processing apparatus according to claim 1, wherein the one or more programs further include instructions for:
associating, with each of the plurality of learning regions, the three-dimensional space model having at least parameters indicating volume densities equal in number to objects included in the learning region.

4. The information processing apparatus according to claim 1, wherein
the three-dimensional space model indicates radiance fields in the associated learning region.

5. The information processing apparatus according to claim 1, wherein
the three-dimensional space model is a learning model formed by one or more multi-layer perceptrons.

6. The information processing apparatus according to claim 1, wherein the one or more programs further include instructions for:
obtaining three-dimensional shape data indicating a three-dimensional shape of each of the plurality of objects estimated based on the plurality of captured images and the camera parameter; and
obtaining the object information based on the three-dimensional shape data corresponding to each of the plurality of objects.

7. The information processing apparatus according to claim 6, wherein the one or more programs further include instructions for:
obtaining the three-dimensional shape data corresponding to each of the plurality of objects by estimating a three-dimensional shape of each of the plurality of objects based on the plurality of captured images and the camera parameter.

8. The information processing apparatus according to claim 6, wherein the one or more programs further include instructions for:
obtaining the object information by regarding a set of a plurality of constituent elements which constitute the three-dimensional shape data and are spatially continuous as a three-dimensional shape corresponding to one object.

9. The information processing apparatus according to claim 6, wherein the one or more programs further include instructions for:
generating a silhouette image by projecting the three-dimensional shape corresponding to each of the plurality of objects on an image plane corresponding to each of the plurality of captured images for each object of the plurality of objects using the camera parameter; and
performing learning of the three-dimensional space model by calculating a loss using at least a pixel value of each of the plurality of captured images and a pixel value of the silhouette image.

10. The information processing apparatus according to claim 1, wherein the one or more programs further include instructions for:
obtaining data on a silhouette image generated by projecting a three-dimensional shape of each of the plurality of objects estimated based on the plurality of captured images and the camera parameter on an image plane corresponding to each of the plurality of captured images for each object of the plurality of objects using the camera parameter; and
performing learning of the three-dimensional space model by calculating a loss using at least a pixel value of each of the plurality of captured images and a pixel value of the silhouette image.

11. The information processing apparatus according to claim 1, wherein the one or more programs further include instructions for:
generating an image corresponding to a view from an arbitrary virtual viewpoint using a result of learning of the three-dimensional space model.

12. An information processing method comprising the steps of:
obtaining data on a plurality of captured images obtained through image capturing from a plurality of viewpoints and a camera parameter in image capturing of each of the plurality of captured images;
obtaining object information indicating a position of each of a plurality of objects included as representations in the captured images;
setting a plurality of learning regions based on the object information;
associating a three-dimensional space model with each of the plurality of learning regions based on a number of objects included in each of the plurality of learning regions; and
performing learning of the three-dimensional space model associated with each of the plurality of learning regions based on the data on the plurality of captured images, the camera parameter, and the object information.

13. A non-transitory computer readable storage medium storing a program for causing a computer to perform a control method of an information processing apparatus, the control method comprising the steps of:
obtaining data on a plurality of captured images obtained through image capturing from a plurality of viewpoints and a camera parameter in image capturing of each of the plurality of captured images;
obtaining object information indicating a position of each of a plurality of objects included as representations in the captured images;
setting a plurality of learning regions based on the object information;
associating a three-dimensional space model with each of the plurality of learning regions based on a number of objects included in each of the plurality of learning regions; and
performing learning of the three-dimensional space model associated with each of the plurality of learning regions based on the data on the plurality of captured images, the camera parameter, and the object information.
